(19) United States
(12) Patent Application Publication
(10) Pub. No.: US 2021/0357078 A1
(43) Pub. Date: Nov. 18, 2021

(54) TOUCH PANEL, MANUFACTURING METHOD THEREOF AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Yadong YUAN, Beijing (CN); Weijie MA, Beijing (CN); Pengyu ZHANG, Beijing (CN); Haifeng HU, Beijing (CN); Jun CHEN, Beijing (CN); Yaping MA, Beijing (CN); Yangjie LI, Beijing (CN); Cui CHEN, Beijing (CN); Xue CHENG, Beijing (CN)

(21) Appl. No.: 16/622,086

(22) PCT Filed: Jun. 25, 2019
(86) PCT No.: PCT/CN2019/092719

§ 371 Date: Dec. 12, 2019

(30) Foreign Application Priority Data
Jun. 28, 2018 (CN) 201810688757.2

(51) Int. Cl. G06F 3/044

(52) U.S. Cl. CPC G06F 3/0446; G06F 2203/04111; G06F 2203/04103; G06F 3/0445

(57) ABSTRACT

A touch panel, a method for manufacturing the same and a display device are provided in the disclosure. The method for manufacturing the touch panel includes: forming a first conductive layer on a base substrate; performing a patterning process on the first conductive layer to form a first conductive layer pattern, wherein the first conductive layer pattern includes two etched regions and a non-etched region which are formed at a preset intersection position where a first touch electrode and a second touch electrode intersect with each other; forming an insulation pattern at the preset intersection position, wherein the insulation pattern is filled in the two etched regions and covers the non-etched region; forming a second conductive layer, wherein the first conductive layer and the second conductive layer constitute a conductive layer; and performing a patterning process on the conductive layer.

### CROSS-REFERENCE TO RELATED APPLICATIONS

The present application claims the priority of Chinese Patent Application No. 201810688757.2, filed to China National Intellectual Property Administration on Jun. 28, 2018, the content of which is incorporated herein by reference in its entirety.

### TECHNICAL FIELD

The disclosure relates to the field of touch technology, and in particular, to a touch panel, a method for manufacturing the same and a display device.

### BACKGROUND

Touch panels have become a main human-computer interaction means of personal mobile communication devices and integrated information terminals such as tablet computers, smart phones, super notebook computers and the like due to its advantages such as simple operation, visualization, flexibility and the like. Touch screens can be classified into four main types including resistive touch screens, capacitive touch screens, infrared touch screens, and surface wave (SAW) touch screens according to different touch principles.

### SUMMARY

According to an aspect of the disclosure, a method for manufacturing a touch panel is provided. The touch panel includes a first touch electrode and a second touch electrode which are insulated from and intersect with each other. The method includes: forming a first conductive layer on a base substrate; performing a patterning process on the first conductive layer to form a first conductive layer pattern, wherein the first conductive layer pattern includes two etched regions and a non-etched region between the two etched regions, the two etched regions and the non-etched region being formed at a preset intersection position where the first touch electrode and the second touch electrode intersect with each other and a non-etched region between the two etched regions; forming an insulation pattern on a side of the first conductive layer pattern distal to the base substrate and at the preset intersection position where the first touch electrode and the second touch electrode intersect with each other, wherein an orthographic projection of the insulation pattern on the base substrate is overlapped with the two etched regions and the non-etched region, and the insulation pattern is filled in the two etched regions and covers the non-etched region; forming a second conductive layer on a side of the first conductive layer and the insulation pattern distal to the base substrate, wherein the first conductive layer and the second conductive layer jointly constitute a conductive layer; and performing a patterning process on the conductive layer to form the first touch electrode and the second touch electrode.

In an embodiment, the pattering process on the first conductive layer is performed, such that the first conductive layer in the non-etched region is formed into a first bridge for connecting portions of the first touch electrode on two sides of the preset intersection position. The patterning process on the conductive layer is performed, such that a portion of the second conductive layer on the insulation pattern is formed into a second bridge for connecting portions of the second touch electrode on two sides of the preset intersection position.

In an embodiment, performing the patterning process on the first conductive layer includes: performing the patterning process on the first conductive layer to form first touch electrode transition patterns, second touch electrode transition patterns and the first bridge, wherein the etched regions are formed at an intersection position where the first touch electrode transition patterns and the second touch electrode transition patterns intersect with each other and between the first touch electrode transition patterns and the second touch electrode transition patterns adjacent to the first touch electrode transition patterns, and adjacent second touch electrode transition patterns are connected through the first bridge. Performing the patterning process on the conductive layer includes: performing the patterning process on the second conductive layer to form third touch electrode transition patterns in contact with the first touch electrode transition patterns, fourth touch electrode transition patterns in contact with the second touch electrode transition patterns, and the second bridge for connecting adjacent third touch electrode transition patterns. The first touch electrode transition patterns, the third touch electrode transition patterns and the second bridge jointly constitute the second touch electrode, and the second touch electrode transition patterns, the fourth touch electrode transition patterns and the first bridge jointly constitute the first touch electrode.

In an embodiment, performing the patterning process on the first conductive layer includes: forming two through holes as the two etched regions at the preset intersection position in the first conductive layer, and performing the patterning process on the conductive layer includes: performing the patterning process on the first conductive layer and the second conductive layer to form the first touch electrode and the second touch electrode.

In an embodiment, a sum of thicknesses of the first conductive layer and the second conductive layer is equal to a thickness of one of the first touch electrode and the second touch electrode.

In an embodiment, a thickness of each of the first conductive layer and the second conductive layer is half of the thickness of one of the first touch electrode and the second touch electrode.

In an embodiment, each of the first conductive layer and the second conductive layer is made of a transparent conductive material or metal.

In an embodiment, the method further includes: forming a planarization layer covering the first touch electrode and the second touch electrode, after performing the patterning process on the conductive layer.

According to an aspect of the disclosure, a touch panel is provided. The touch panel includes a first touch electrode and a second touch electrode that are insulated from and intersect with each other. The touch panel includes: a first conductive layer pattern, on a base substrate; an insulation pattern, on a side of the first conductive layer pattern distal to the base substrate and at a preset intersection position where the first touch electrode and the second touch electrode intersect with each other; and a second conductive layer pattern, on a side of the first conductive layer pattern and the insulation pattern distal to the base substrate. A region of the first conductive layer pattern where the insulation pattern is formed includes two etched regions and a non-etched region between the two etched regions, and the insulation pattern is filled in the two etched regions and covers the non-etched region. The first conductive layer pattern and the second conductive layer pattern jointly constitute the first touch electrode and the second touch electrode.

In an embodiment, the first conductive layer pattern in the non-etched region serves as a first bridge for connecting portions of the first touch electrode on two sides of the preset intersection position. A portion of the second conductive layer pattern on the insulation pattern serves as a second bridge for connecting portions of the second touch electrode on two sides of the preset intersection position.

In an embodiment, a sum of thicknesses of the first conductive layer pattern and the second conductive layer pattern is equal to a thickness of one of the first touch electrode and the second touch electrode.

In an embodiment, a thickness of each of the first conductive layer pattern and the second conductive layer pattern has a thickness that is half of the thickness of one of the first touch electrode and the second touch electrode.

In an embodiment, each of the first conductive layer pattern and the second conductive layer pattern is made of a transparent conductive material or metal.

In an embodiment, the first touch electrode includes first touch sub-electrodes each having a block shape and connected through the first bridge; and the second touch electrode includes second touch sub-electrodes each having a block shape and connected through the second bridge.

In an embodiment, the first touch electrode and the second touch electrode both have a strip shape, and a width of the non-etched region between the two etched regions is equal to a line width of each of the first touch electrode and the second touch electrode.

In an embodiment, the touch panel includes a plurality of first touch electrodes which are parallel to each other and a plurality of second touch electrodes which are parallel to each other.

In an embodiment, the touch panel includes a plurality of first touch electrodes which are arranged in a grid shape and a plurality of second touch electrodes which are arranged in a grid shape.

In an embodiment, the touch panel further includes a planarization layer covering the first touch electrode and the second touch electrode.

According to an aspect of the disclosure, a display device including the touch panel described above is provided.

### BRIEF DESCRIPTION OF THE DRAWINGS

FIGS. 1-5 are schematic diagrams showing states of a touch panel manufactured according to an embodiment of the disclosure;

FIG. 6 is a cross-sectional view of an overlapped region where first and second touch electrodes overlap with each other, taken along an AA′ direction in FIG. 5:

FIG. 7 is a cross-sectional view of the overlapped region where the first and second touch electrodes overlap with each other, taken along a BB′ direction in FIG. 5;

FIGS. 8-12 are schematic diagrams showing states of a touch panel manufactured according to an embodiment of the disclosure:

FIG. 13 is a cross-sectional view of an overlapped region where first and second touch electrodes overlap with each other, taken along an AA direction in FIG. 12:

FIG. 14 is a cross-sectional view of the overlapped region where the first and second touch electrodes overlap with each other, taken along a BB′ direction in FIG. 12;

FIG. 15 is a schematic diagram showing a layout of first touch electrodes and second touch electrodes of a touch panel according to an embodiment of the disclosure;

FIG. 16 is a schematic diagram showing a layout of first touch electrodes and second touch electrodes of a touch panel according to an embodiment of the disclosure; and

FIG. 17 is a flow chart showing a method for manufacturing a touch panel according to an embodiment of the disclosure.

### DETAILED DESCRIPTION

The specific embodiments of the present disclosure will be described in detail below with reference to the accompanying drawings. It is to be understood that the specific embodiments described herein are provided for purposes of explaining and illustrating the present disclosure, rather than limiting the present disclosure.

According to the related art, when a touch electrode is manufactured, a first conductive layer is formed on a base substrate by a sputtering process, such that a thickness of the first conductive layer is equal to a thickness of a first touch electrode; thereafter a patterning process is performed on the first conductive layer to form a first touch electrode; then a planarization layer is formed; a second conductive layer is formed on the planarization layer by a sputtering process, such that a thickness of the second conductive layer is equal to a thickness of a second touch electrode; and then the patterning process is performed on the second conductive layer to form the second touch electrode. Since the first and second conductive layers are generally formed by two patterning processes, the consumption of target material is very high, thereby resulting in high production cost, complex process, high manufacturing risk, and poor controllability of the process. In a case that the touch electrodes are made of a transparent conductive material, a transparent conductive pattern has to climb, and therefore defects such as line breakage, undercut and the like exist in the re-making process.

A method for manufacturing a touch panel is provided in an embodiment of the disclosure. The touch panel includes first and second touch electrodes to be formed, and the method includes the followings steps.

A first conductive layer is formed on a base substrate. A thickness of the first conductive layer is smaller than a thickness of the first or second touch electrode.

A patterning process is performed on the first conductive layer to form a first conductive layer pattern.

An insulation pattern is formed on a side of the first conductive layer pattern distal to the base substrate and at a preset intersection position where the first and the second touch electrodes to be formed intersect with each other. A region of the first conductive layer pattern where the insulation pattern is formed includes two etched regions which are spaced apart by a preset distance and a non-etched region between the two etched regions.

A second conductive layer is formed on a side of the first conductive layer pattern and the insulation pattern distal to the base substrate. The first conductive layer and the second conductive layer jointly constitute a conductive layer. A sum of the thicknesses of the first conductive layer and the second conductive layer is equal to a thickness of the first or second touch electrode.

The patterning process is performed on the conductive layer to form the first touch electrode and the second touch electrode which are insulated from and intersect with each other.

In this embodiment, when the touch electrode is manufactured, the first conductive layer and the second conductive layer are formed respectively. Each of the thicknesses of the first conductive layer and the second conductive layer is smaller than the thickness of the first or second touch electrode, and the sum of the thicknesses of the second conductive layer and the first conductive layer is equal to the thickness of the first or second touch electrode. The second conductive layer and the first conductive layer jointly form the first touch electrode, and the second conductive layer and the first conductive layer jointly form the second touch electrode. That is, the first touch electrode and the second touch electrode are formed by two conductive layers, rather than forming the first touch electrode by using the first conductive layer and then forming the second touch electrode by using the second conductive layer as in the related art. Therefore, compared with the related art, in a case that the thickness of the touch electrode does not change, the consumption of the conductive material is reduced by half, and in turn the production cost is reduced.

In an embodiment, the first conductive layer and the second conductive layer may be made of a transparent conductive material, such as ITO, IZO. Alternatively, the first conductive layer and the second conductive layer may be made of metal such as Al, Ag, Au, or the like in order to reduce cost.

In an embodiment, the method further includes: forming a planarization layer covering the first touch electrode and the second touch electrode after forming a second conductive layer pattern. On one hand, the planarization layer can protect the first touch electrode and the second touch electrode, and on another hand, the planarization layer can provide a flat surface for subsequent processes.

Each of the thicknesses of the first conductive layer and the second conductive layer may be half of the thickness of the first or second touch electrode. Alternatively, the thicknesses of the first conductive layer and the second conductive layer may also have other values, as long as the sum of the thicknesses of the first conductive layer and the second conductive layer is equal to the thickness of the first touch electrode (or the second touch electrode), but the difference between the thicknesses of the first conductive layer and the second conductive layer should not be too large.

In an embodiment, the patterning process performed on the first conductive layer to form the first conductive layer pattern includes: forming two etched regions spaced apart by a preset distance in a region of the first conductive layer corresponding to the preset intersection position.

The patterning process performed on the second conductive layer to form the second conductive layer pattern includes: removing a portion of the conductive layer except the first and second touch electrodes to form the first touch electrode and the second touch electrode. The conductive layer may include the first conductive layer and the second conductive layer, or may include only the second conductive layer. A portion of the second conductive layer corresponding to the two etched regions spaced apart by the preset distance is formed into a second bridge.

At the same time when the two etched regions spaced apart by the preset distance are formed at the preset intersection position of the first conductive layer where the first touch electrode and the second touch electrode intersect with each other, the portion of the first conductive layer except the first touch electrode and the second touch electrode is removed, so that at the same time when the etched regions are formed, a portion of the first touch electrode and a portion of the second touch electrode are formed.

In an embodiment, a method for manufacturing a touch panel may include the following steps.

The first conductive layer is formed on the base substrate. The thickness of the first conductive layer is smaller than the thickness of the first or second touch electrode to be formed.

The patterning process is performed on the first conductive layer to form first touch electrode transition patterns, second touch electrode transition patterns and a first bridge. The etched regions are formed at the intersection position where the first touch electrode transition patterns and the second touch electrode transition patterns intersect with each other and between the first touch electrode transition patterns and the second touch electrode transition patterns adjacent to the first touch electrode transition patterns. The adjacent second touch electrode transition patterns are connected through the first bridge.

The insulation pattern is formed at the intersection position, and the insulation pattern is filled in each of the etched regions and covers a non-etched region.

The second conductive layer is formed on the first conductive layer and the insulation pattern. The patterning process is performed on the second conductive layer to form third touch electrode transition patterns in contact with the first touch electrode transition patterns, fourth touch electrode transition patterns in contact with the second touch electrode transition patterns, and a second bridge. A portion of the second conductive layer located on the insulation pattern is formed into the second bridge for connecting two adjacent third touch electrode transition patterns. The first bridge, the second touch electrode transition patterns and the fourth touch electrode transition patterns jointly constitute the first touch electrode; and the second bridge, the first touch electrode transition patterns and the third touch electrode transition patterns jointly constitute the second touch electrode.

In an embodiment, the first conductive layer and the second conductive layer may be formed by a sputtering process. The formation of the first conductive layer includes: forming the first conductive layer by the sputtering process. The formation of the second conductive layer includes: forming the second conductive layer by the sputtering process.

In an embodiment, a method for manufacturing a touch panel includes the following steps.

The first conductive layer is formed on a base substrate. The thickness of the first conductive layer is half of the thickness of the first or the second touch electrode.

The patterning process is performed on the first conductive layer, such that two etched regions (i.e., through holes) spaced apart by a preset distance are formed at the preset intersection position in the first conductive layer where the first touch electrode and the second touch electrode intersect with each other. The non-etched region is located between the two etched regions.

The insulation pattern covering and filling (e.g., fully filling) each of the etched regions and covering the non-etched region is formed at the preset intersection position.

The second conductive layer is formed on a side of the first conductive layer and the insulation pattern distal to the base substrate. The patterning process is performed simultaneously on the first conductive layer and the second conductive layer, so that a portion of the second conductive layer on the insulation pattern is formed into a second bridge. The first conductive layer and the second conductive layer jointly form the first touch electrode and the second touch electrode which are insulated from each other by the insulation pattern, and intersect with each other.

Alternatively, the thicknesses of the first conductive layer and the second conductive layer may also have other values, as long as the sum of the thicknesses of the first conductive layer and the second conductive layer is equal to the thickness of the first or second touch electrode, but the difference between the thicknesses of the first conductive layer and the second conductive layer should not be too large.

After the second conductive layer is formed, adjacent second conductive layer patterns are connected through the first bridge (i.e., the first conductive layer in the non-etched region). A portion of the second conductive layer between the two through holes spaced apart by a preset distance (i.e., a portion of the second conductive layer located on the insulation pattern) is formed into the second bridge.

The first and second touch electrodes may both have a block shape or a stripe shape. In an embodiment, in a case that the first and second touch electrodes both have a stripe shape, a line width of the touch electrode is equal to a line width of the bridge between the touch electrodes, in order to ensure the uniformity of transmittance. Therefore, the line widths of the first touch electrode and the second touch electrode may be equal to the preset distance.

In an embodiment, the first conductive layer and the second conductive layer may be formed by a sputtering process. The formation of the first conductive layer includes: forming the first conductive layer by the sputtering process; and the formation of the second conductive layer includes: forming the second conductive layer by the sputtering process.

A method for manufacturing a touch panel according to the present disclosure will be described below with reference to the accompanying drawings and specific embodiments.

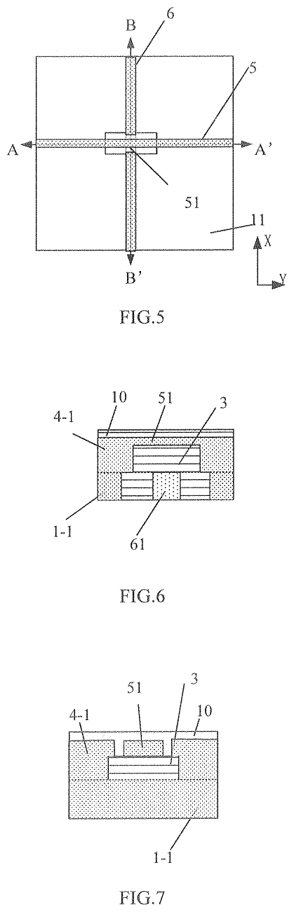

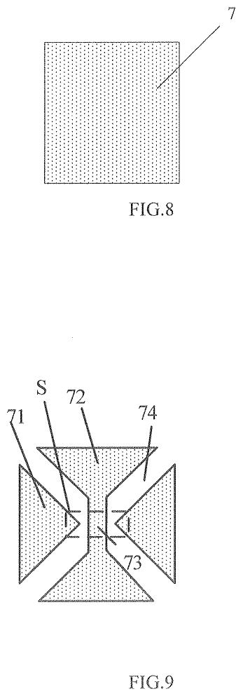

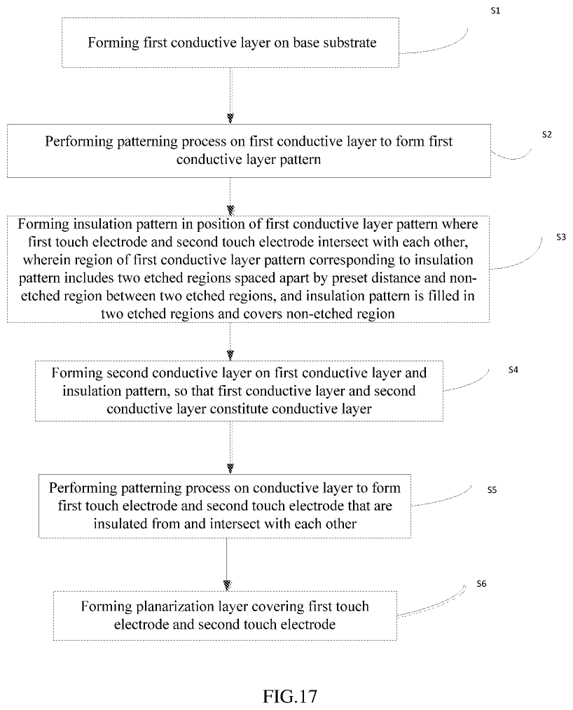

FIGS. 1-5 are schematic diagrams showing states of a touch panel manufactured according to an embodiment of the disclosure. FIG. 6 is a cross-sectional view of an overlapped region where first and second touch electrodes overlap with each other, taken along an AA′ direction in FIG. 5. FIG. 7 is a cross-sectional view of an overlapped region where the first and second touch electrodes overlap with each other, taken along a BB′ direction in FIG. 5. FIG. 17 is a flow chart showing a method for manufacturing a touch panel according to an embodiment of the disclosure. The method for manufacturing the touch panel includes steps S1 to S6. The present embodiment in which the first and second touch electrodes have a stripe shape is described as an example, but the shapes of the first and second touch electrodes are not limited thereto.

At step S1, as shown in FIG. 1, a first conductive layer 1 is formed on a base substrate 11 by a sputtering process. A thickness of the first conductive layer 1 may be half of a thickness of the first touch electrode or the second touch electrode.

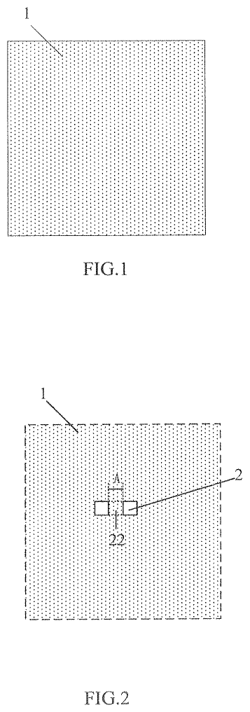

At step S2, as shown in FIG. 2, a patterning process is performed on the first conductive layer 1, such that two etched regions 2 (or through holes) spaced apart by a preset distance A are etched at a preset intersection position in the first conductive layer 1 where the first touch electrode and the second touch electrode intersect with each other, and a non-etched region 22 is located between the two etched regions 2 and serves as a first bridge 61 as will be described later. The first bridge 61 is used for connecting two portions of the first touch electrode 6 located at both sides of the preset intersection position along an X direction. In an embodiment, in order to ensure the uniformity of transmittance, the preset distance A is equal to a line width of the first touch electrode 5 and is equal to a line width of the second touch electrode 6.

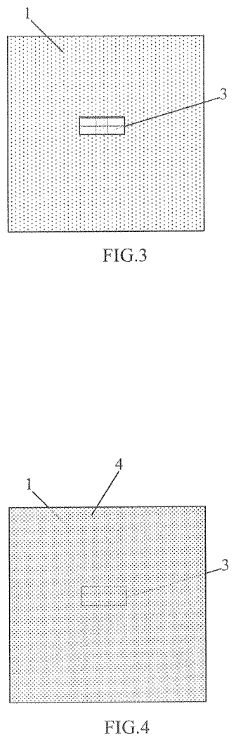

At step S3, as shown in FIG. 3, an insulation pattern 3 is formed on a side of a first conductive layer pattern distal to the base substrate and at the preset intersection position where the first touch electrode and the second touch electrode to be formed intersect with each other. The insulation pattern 3 is filled in each of the etched regions 2 and covers the non-etched region 22.

For example, a layer of insulation material may be formed on the first conductive layer pattern 1, and the patterning process is performed on the insulation material to form an insulation pattern 3.

At step S4, as shown in FIG. 4, a second conductive layer 4 is formed on the first conductive layer 1 and the insulation pattern 3 by a sputtering process.

A thickness of the second conductive layer 4 may be half of a thickness of the first touch electrode or the second touch electrode, and a material of the second conductive layer 4 may be the same as a material of the first conductive layer 1.

At step S5, as shown in FIG. 5, the patterning process is performed simultaneously on the first conductive layer 1 and the second conductive layer 4. The first conductive layer 1 and the second conductive layer 4 jointly form the first touch electrode 5 and the second touch electrode 6. A portion of the second conductive layer 4 located on the insulation pattern 3 is formed into a second bridge 51, as shown in FIGS. 5 and 6. The second bridge 51 is used for connecting portions of the second touch electrode 5 on both sides of the insulation pattern along a Y direction which intersects with the X direction. The second bridge 51 is insulated and spaced apart from the first touch electrode 6.

In an embodiment, the patterning process performed on the first conductive layer 1 and the second conductive layer 4 includes: partially exposing the insulation pattern 3; and remaining a portion 51 of the second conductive layer 4 located on the insulation pattern 3. A sum of the thicknesses of the first conductive layer 1 and the second conductive layer 2 is equal to the thickness of the first touch electrode 6 (or the second touch electrode 5). At the same when the patterning process is performed on the first conductive layer 1 and the second conductive layer 4 to form the first touch electrode and the second touch electrode, the manufacturing of the wiring of touch signal wires and the wiring in binding region can be completed.

FIG. 6 is a cross-sectional view of an overlapped region where the first and second touch electrodes 5 and 6 overlap with each other, taken along an AA direction. FIG. 7 is a cross-sectional view of the overlapped region where the first and second touch electrodes 5 and 6 overlap with each other, taken along a BB′ direction. The first bridge 61 (i.e., the first conductive layer in the non-etched region), two portions of the first conductive layer 1 connected by the first bridge 61, and two portions of the second conductive layer 4 in contact with the two portions of the first conductive layer 1 jointly constitute the first touch electrode 6. The second bridge 51, two portions of the second conductive layer 4 connected by the second bridge 51, and two portions of the first conductive layer 1 in contact with the two portions of the second conductive layer 4 jointly constitute the second touch electrode 5.

At step S6, as shown in FIGS. 6 and 7, a planarization layer 10 covering the first touch electrode 5 and the second touch electrode 6 is formed.

On one hand, the planarization layer 10 can protect the first touch electrode 5 and the second touch electrode 6, and on another hand, the planarization layer 10 can provide a flat surface for subsequent processes. In an embodiment, a material of the planarization layer 10 may be the same as an insulation material of the insulation pattern 3.

According to the technical solution of the embodiment, the first touch electrode, the second touch electrode, the wiring of touch signal lines and the wiring in the binding region can be simultaneously formed by using the first conductive layer and the second conductive layer. Compared with the related art, in the embodiment, the consumption of the material such as the metal target material is reduced by half, and the production cost of the touch panel is reduced. The first touch electrode 5 and the second touch electrode 6 are located on a same plane, thereby resulting in a more uniform grid density and better shadow eliminating effect. Furthermore, the first touch electrode 5 and the second touch electrode 6 are formed in a same patterning process, thereby reducing the process risk and improving the controllability of the process. In addition, in the technical solution of the embodiment, sheet resistances of the first touch electrode and the second touch electrode can be reduced by adjusting the thicknesses of the first conductive layer and the second conductive layer.

It is noted that the first touch electrode and the second touch electrode manufactured according to the method shown in FIGS. 1 to 7 may also have a square shape (as shown in FIG. 12), a diamond shape, a rectangular shape, a circular shape, or the like.

According to the method for manufacturing a touch panel shown in FIGS. 1 to 7, the first touch electrode and the second touch electrode may be made of any one of a metal material and a transparent conductive material. In a case that the touch electrodes have a block shape and are made of metal, the first touch electrode and the second touch electrode can be made of a metal grid film layer.

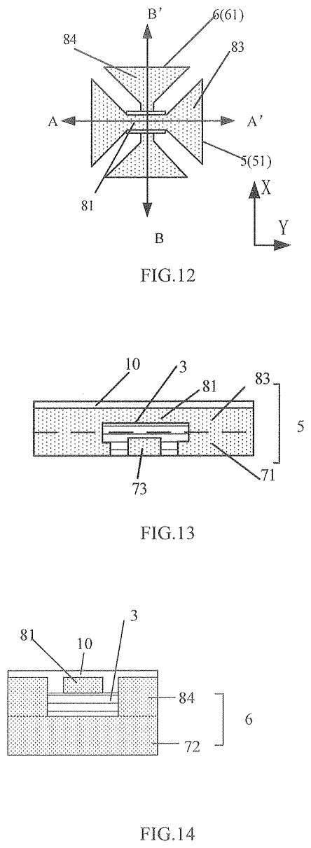

FIGS. 8-12 are schematic diagrams showing states of a touch panel manufactured according to an embodiment of the disclosure. FIG. 13 is a cross-sectional view of an overlapped region where first and second touch electrodes overlap with each other, taken along an AA direction in FIG. 12. FIG. 14 is a cross-sectional view of an overlapped region where the first and second touch electrodes overlap with each other, taken along a BB′ direction in FIG. 12. FIG. 17 is a flow chart showing a method for manufacturing a touch panel according to an embodiment of the disclosure. It is to be noted that an embodiment in which the first and second touch electrodes have a block shape as shown in FIGS. 8-12 described as an example, but the shapes of the first and second touch electrodes are not limited thereto.

The method for manufacturing a touch panel according to the embodiment of the present disclosure includes steps S1 to S6.

At step S1, as shown in FIG. 8, a first conductive layer 7 is formed on a base substrate 11 by a sputtering process. A thickness of the first conductive layer 7 may be half of a thickness of the first touch electrode or the second touch electrode.

At step S2, as shown in FIG. 9, a patterning process is performed on the first conductive layer 7 to form first touch electrode transition patterns 71 each having a block shape, second touch electrode transition patterns 72 each having a block shape, and a first bridge 73. Two adjacent second touch electrode transition patterns 72 are connected through the first bridge 73. Two etched regions and a non-etched region located between the two etched regions are formed at an intersection position S of a first conductive layer pattern 7 where the first touch electrode transition patterns 71 and the second touch electrode transition patterns 72 intersect with each other and between the first touch electrode transition patterns 71 and the second touch electrode transition patterns 72 adjacent thereto (i.e., in a region S where the insulation pattern is to be formed). The adjacent second touch electrode transition patterns 72 are connected through the first bridge 73 (i.e., the first conductive layer pattern in the non-etched region).

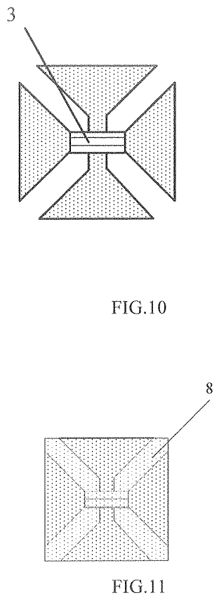

At step S3, as shown in FIG. 10, an insulation pattern 3 is formed at the intersection position. The insulation pattern 3 is filled in each of the etched regions and covers the non-etched region.

For example, a layer of insulation material may be formed on the first conductive layer pattern 7 that is patterned, and the patterning process is performed on the insulation material to form the insulation pattern 3.

At step S4, as shown in FIG. 11, a second conductive layer 8 is formed on the first conductive layer 7 and the insulation pattern 3 by a sputtering process. A sum of the thicknesses of the second conductive layer 8 and the first conductive layer 7 is equal to a thickness of the first or second touch electrode. A material of the second conductive layer 8 is the same as a material of the first conductive layer 7. A portion of the second transparent conductive layer 8 located on the insulation pattern 3 is formed into a second bridge for connecting the adjacent first touch electrode transition patterns 71.

At step S5, as shown in FIG. 12, the patterning process is performed on the second conductive layer 8 to form third touch electrode transition patterns 83 each having a block shape and corresponding to (or in contact with) the first touch electrode transition patterns 71, fourth touch electrode transition patterns 84 each having a block shape and corresponding to (or in contact with) the second touch electrode transition patterns 72, and the second bridge 81 for connecting two adjacent third touch electrode transition patterns 83. The second bridge 81, the first touch electrode transition patterns 71 and the third touch electrode transition patterns 83 jointly constitute the second touch electrode 5. The first bridge 73, the second touch electrode transition patterns 72, and the fourth touch electrode transition patterns 84 jointly constitute the first touch electrode 6.

In an embodiment, the patterning process performed on the second conductive layer 8 includes: partially exposing the insulation pattern 3; and remaining a portion (i.e., the second bridge 81) of the second conductive layer 8 located on the insulation pattern.

In an embodiment, the first conductive layer 7 and the second conductive layer 8 are made of the same material.

The thickness of the first touch electrode 5 or the second touch electrode 6 is equal to the sum of the thicknesses of the first conductive layer 7 and the second conductive layer 8. The first touch electrode 5 is one of a driving electrode and a sensing electrode, and the second touch electrode 6 is the other of the driving electrode and the sensing electrode.

At step S6, a planarization layer 10 covering the first touch electrode 5 and the second touch electrode 6 is formed.

On one hand, the planarization layer 10 can protect the first touch electrode 5 and the second touch electrode 6, and on another hand, the planarization layer 10 can provide a flat surface for subsequent processes.

It is to be noted that the first touch electrode and the second touch electrode manufactured according to the method shown in FIGS. 8-14 and 17 may also have other shape such as a stripe shape (as shown in FIG. 5), a diamond shape, a circle shape, or the like.

The first touch electrode and the second touch electrode shown in FIGS. 8 to 14 may be made of any one of a metal material and a transparent conductive material. The material of the first touch electrode and the second touch electrode is not limited thereto. In a case that the touch electrode has a block shape and is made of metal, the first touch electrode and the second touch electrode can be made of a metal grid film layer.

According to the present embodiment, the first conductive layer and the second conductive layer jointly form the first touch electrode and the second touch electrode.

Compared with the prior art, the consumption of the transparent conductive target material is reduced by half, and the production cost of the touch panel is reduced. The first conductive layer and the second conductive layer formed by the sputtering process have a reduced thickness, thereby simplifying the steps of the sputtering process and improving the equipment activation. In addition, in the technical solution of the embodiment, the sheet resistances of the first touch electrode and the second touch electrode can be reduced by adjusting the thicknesses of the first conductive layer and the second conductive layer. Moreover, in a case that the first conductive layer and the second conductive layer are made of the transparent conductive material, the transparent conductive pattern may climb to a reduced height, and risks such as line breakage, undercut are reduced.

A touch panel including the first touch electrode and the second touch electrode is provided in an embodiment of the disclosure. As shown in FIGS. 5 and 12, the touch panel includes: a first conductive layer pattern 1, an insulation pattern 3, and a second conductive layer pattern 4.

Two etched regions 2 spaced apart from each other by a preset distance and a non-etched region 22 between the two etched regions 2 are located in the first conductive layer pattern 1. The insulation pattern 3 is filled in the two etched regions 2 and covers each of the etched regions 1 and the non-etched region 22.

The non-etched region 22 serves as a first bridge 61 for connecting two portions of the first conductive layer pattern 1 located at both sides of the insulation pattern 3 along an X direction.

The second conductive layer pattern 4 is located on the first conductive layer pattern 1 and the insulation pattern 3. A portion of the second conductive layer pattern 4 located on the insulation pattern 3 serves as a second bridge 51 for connecting two portions of the second conductive layer pattern 4 located at both sides of the insulation pattern 3 in a Y direction. The second bridge 51 is insulated and spaced apart from the first touch electrode 6.

The first bridge 61 (i.e., the first conductive layer pattern in the non-etched region 22), the two portions of the first conductive layer pattern 1 connected by the first bridge 61, and the two portions of the second conductive layer pattern 4 in contact with the two portions of the first conductive layer pattern 1 jointly constitute the first touch electrode 6. The second bridge 51, the two portions of the second conductive layer pattern 4 connected by the second bridge 51, and the two portions of the first conductive layer pattern 1 in contact with the two portions of the second conductive layer pattern 4 jointly constitute the second touch electrode 5. In an embodiment, as shown in FIGS. 6 and 7, the first touch electrode includes the first bridge 61, and the first conductive layer pattern and the second conductive layer pattern that are located at both sides of the insulation pattern 3 along the X direction. The second touch electrode includes the second bridge 51, and the first conductive layer pattern and the second conductive layer pattern that are located on both sides of the insulation pattern 3 along the Y direction.

The planarization layer 10 covers the second conductive layer 4 and the insulation pattern 3, and the material of the planarization layer 10 is the same as the insulation material of the insulation pattern 3.

The first touch electrode 5 is one of a driving electrode and a sensing electrode, and the second touch electrode 6 is the other of the driving electrode and the sensing electrode.

The thicknesses of the first conductive layer pattern 1 and the second conductive layer pattern 2 are both smaller than the thickness of the first touch electrode or the second touch electrode. The sum of the thicknesses of the second conductive layer pattern 4 and the first conductive layer pattern 1 is equal to the thickness of each of the first and second touch electrodes. The thickness of each of the second conductive layer pattern 2 and the first conductive layer pattern 1 is equal to half of the thickness of the first touch electrode or the second touch electrode.

In an embodiment, the first conductive layer and the second conductive layer may be made of the same conductive material such as metal or the transparent conductive material.

In an embodiment, the first touch electrode and the second touch electrode may have any one of a stripe shape, a block shape, a diamond shape, and a circular shape. In a case that the touch electrode has a block shape and is made of metal, the first touch electrode and the second touch electrode can be made of a metal grid film layer.

In the embodiment, the first touch electrode and the second touch electrode are both formed by the first conductive layer and the second conductive layer which are stacked, that is, the first conductive layer and the second conductive layer jointly form the first touch electrode and the second touch electrode, rather than forming the first touch electrode by using an individual conductive layer and then forming the second touch electrode by using another individual conductive layer as in the related art. Therefore, in a case that the thickness of the touch electrode does not change, the consumption of the conductive material is reduced by half, and in turn the production cost is reduced.

FIG. 15 is a schematic diagram showing a layout of first touch electrodes and second touch electrodes of a touch panel according to an embodiment of the disclosure. As shown in FIG. 15, the touch panel includes a plurality of first touch electrodes each having a stripe shape and a plurality of second touch electrodes each having a stripe shape. The plurality of first touch electrodes are parallel to each other, and the plurality of second touch electrodes are parallel to each other. The plurality of first touch electrodes and the plurality of second touch electrodes intersect with each other and are arranged in a grid shape. The first touch electrode and the second touch electrode are manufactured according to the manufacturing method of the embodiment of the present disclosure, at an intersection position (as indicated by the dotted circle) where the first touch electrode and the second touch electrode intersect with each other. The arrangement of the touch electrodes as shown in FIG. 15 has advantages in that: external lead wires for the first touch electrodes are located on two sides such as upper and lower sides of the touch panel; external lead wires for the second touch electrodes are located on two sides such as left and right sides of the touch panel, and therefore the external lead wires of the touch electrodes are orderly arranged and concentrated together, thereby facilitating the realization of narrow-bezel display device.

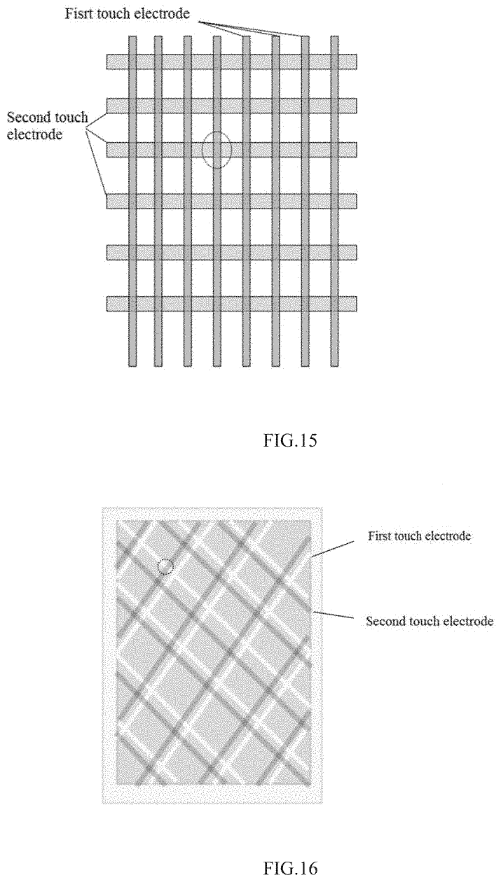

FIG. 16 is a schematic diagram showing a layout of first touch electrodes and second touch electrodes of a touch panel according to an embodiment of the disclosure. As shown in FIG. 16, the touch panel includes a plurality of first touch electrodes each having a stripe shape and a plurality of second touch electrodes each having a stripe shape. The plurality of first touch electrodes intersect with each other and are arranged in a grid shape. The plurality of second touch electrodes intersect with each other and are arranged in a grid shape. The first touch electrode and the second touch electrode are manufactured according to the manufacturing method of the embodiment of the present disclosure, at the intersection position (as indicated by the dotted circle) where the first touch electrode and the second touch electrode intersect with each other.

It is to be noted that an embodiment in which the first and second touch electrodes shown in FIGS. 15 and 16 have a stripe shape is described as an example, and the first touch electrode and the second touch electrode may also have any one of a block shape, a diamond shape, a rectangular shape, and a circular shape.

In the case that the first touch electrode and the second touch electrode have a block shape, the first touch electrode includes two first touch sub-electrodes 61 having a block shape and connected through the first bridge. Each of the first touch sub-electrodes 61 is a stacked layer including the second touch electrode transition pattern 72 and the fourth touch electrode transition pattern 84. The second touch electrode includes two second touch sub-electrodes 51 having a block shape and connected through the second bridge. Each of the second touch sub-electrodes 51 is a stacked layer including the first touch electrode transition pattern 71 and the third touch electrode transition pattern 83. The first touch sub-electrode 61 and the second touch sub-electrode 51 are insulated from each other by the insulation pattern 3.

A display device including the touch panel describe above is provided in an embodiment of the disclosure. The display device may be any product or component with a display function such as a television, a display, a digital photo frame, a mobile phone, a tablet computer, or the like. The display device further includes a flexible circuit board, a printed circuit board and a back plate.

The touch panel can be independently arranged outside a display panel of the display device, and alternatively the touch panel can be embedded in the display panel.

In an embodiment, the display device includes the display panel and the touch panel located on a light-emitting side of the display panel. A base substrate of the touch panel also serves as a base substrate of the display panel, and therefore a thickness of the display device can be reduced.

It should be understood that the above embodiments are merely exemplary embodiments for the purpose of illustrating the principle of the disclosure. However, the present disclosure is not limited thereto. It will be apparent to those skilled in the art that various changes and modifications can be made without departing from the spirit and essence of the present disclosure, and the changes and modifications should be regarded as falling within the scope of the present disclosure.

1. A method for manufacturing a touch panel, the touch panel comprising a first touch electrode and a second touch electrode which are insulated from and intersect with each other, the method comprising:
forming a first conductive layer on a base substrate;
performing a patterning process on the first conductive layer to form a first conductive layer pattern, wherein the first conductive layer pattern comprises two etched regions and a non-etched region between the two etched regions, the two etched regions and the non-etched region being formed at a preset intersection position where the first touch electrode and the second touch electrode intersect with each other;
forming an insulation pattern on a side of the first conductive layer pattern distal to the base substrate and at the preset intersection position where the first touch electrode and the second touch electrode intersect with each other, wherein an orthographic projection of the insulation pattern on the base substrate overlaps with orthographic projections of two etched regions and the non-etched region on the base substrate, and the insulation pattern is filled in the two etched regions and covers the non-etched region;
forming a second conductive layer on a side of the first conductive layer and the insulation pattern distal to the base substrate, wherein the first conductive layer and the second conductive layer jointly constitute a conductive layer; and
performing a patterning process on the conductive layer to form the first touch electrode and the second touch electrode.

2. The method according to claim 1, wherein
the patterning process on the first conductive layer is performed, such that the first conductive layer in the non-etched region is formed into a first bridge for connecting portions of the first touch electrode on two sides of the preset intersection position, and
the patterning process on the conductive layer is performed, such that a portion of the second conductive layer on the insulation pattern is formed into a second bridge for connecting portions of the second touch electrode on two sides of the preset intersection position.

3. The method according to claim 2, wherein
performing the patterning process on the first conductive layer comprises: performing the patterning process on the first conductive layer to form first touch electrode transition patterns, second touch electrode transition patterns and the first bridge, such that the etched regions are formed at the preset intersection position and between the first touch electrode transition patterns and the second touch electrode transition patterns adjacent to the first touch electrode transition patterns, and adjacent second touch electrode transition patterns are connected through the first bridge,
performing the patterning process on the conductive layer comprises: performing the patterning process on the second conductive layer to form third touch electrode transition patterns in contact with the first touch electrode transition patterns, fourth touch electrode transition patterns in contact with the second touch electrode transition patterns, and the second bridge for connecting adjacent third touch electrode transition patterns,
the first touch electrode transition patterns, the third touch electrode transition patterns and the second bridge jointly constitute the second touch electrode, and
the second touch electrode transition patterns, the fourth touch electrode transition patterns and the first bridge jointly constitute the first touch electrode.

4. The method according to claim 2, wherein
performing the patterning process on the first conductive layer comprises: forming two through holes as the two etched regions at the preset intersection position in the first conductive layer, and
performing the patterning process on the conductive layer comprises: performing the patterning process on the first conductive layer and the second conductive layer to form the first touch electrode and the second touch electrode.

5. The method according to claim 1, wherein
a sum of thicknesses of the first conductive layer and the second conductive layer is equal to a thickness of one of the first touch electrode and the second touch electrode.

6. The method according to claim 5, wherein
a thickness of each of the first conductive layer and the second conductive layer is half of the thickness of one of the first touch electrode and the second touch electrode.

7. The method according to claim 1, wherein
each of the first conductive layer and the second conductive layer is made of a transparent conductive material or metal.

8. The method according to claim 1, further comprising: forming a planarization layer covering the first touch electrode and the second touch electrode, after performing the patterning process on the conductive layer.

9. A touch panel, comprising a first touch electrode and a second touch electrode that are insulated from and intersect with each other, the touch panel comprising:
a first conductive layer pattern on a base substrate;
an insulation pattern on a side of the first conductive layer pattern distal to the base substrate and at a preset intersection position where the first touch electrode and the second touch electrode intersect with each other; and
a second conductive layer pattern on a side of the first conductive layer pattern and the insulation pattern distal to the base substrate,
wherein a region of the first conductive layer pattern where the insulation pattern is formed comprises two etched regions and a non-etched region between the two etched regions, and the insulation pattern is filled in the two etched regions and covers the non-etched region, and
the first conductive layer pattern and the second conductive layer pattern jointly constitute the first touch electrode and the second touch electrode.

10. The touch panel according to claim 9, wherein
a portion the first conductive layer pattern in the non-etched region serves as a first bridge for connecting portions of the first touch electrode on two sides of the preset intersection position, and
a portion of the second conductive layer pattern on the insulation pattern serves as a second bridge for connecting portions of the second touch electrode on two sides of the preset intersection position.

11. The touch panel according to claim 9, wherein
a sum of thicknesses of the first conductive layer pattern and the second conductive layer pattern is equal to a thickness of one of the first touch electrode and the second touch electrode.

12. The touch panel according to claim 11, wherein
a thickness of each of the first conductive layer pattern and the second conductive layer pattern has a thickness that is half of the thickness of one of the first touch electrode and the second touch electrode.

13. The touch panel according to claim 9, wherein
each of the first conductive layer pattern and the second conductive layer pattern is made of a transparent conductive material or metal.

14. The touch panel according to claim 10, wherein
the first touch electrode comprises first touch sub-electrodes each having a block shape and connected through the first bridge; and
the second touch electrode comprises second touch sub-electrodes each having a block shape and connected through the second bridge.

15. The touch panel according to claim 10,
the first touch electrode and the second touch electrode both have a strip shape, and
a width of the non-etched region between the two etched regions is equal to a line width of each of the first touch electrode and the second touch electrode.

16. The touch panel according to claim 15, comprising a plurality of first touch electrodes which are parallel to each other and a plurality of second touch electrodes which are parallel to each other.

17. The touch panel according to claim 15, comprising a plurality of first touch electrodes which are arranged in a grid shape and a plurality of second touch electrodes which are arranged in a grid shape.

18. The touch panel according to claim 9, further comprising a planarization layer covering the first touch electrode and the second touch electrode.

19. A display device comprising a touch panel, the touch panel being the touch panel according to claim 9.
